(19) United States
(12) Patent Application Publication
(10) Pub. No.: US 2026/0260023 A1
(43) Pub. Date: Sep. 3, 2026

(54) IMPEDANCE MONITORING SYSTEM

(71) Applicant: NATIONAL UNIVERSITY OF SINGAPORE, Singapore (SG)

(72) Inventors: Himadri Singh RAGHAV, Singapore (SG); Viveka KONANDUR RAJANNA, Singapore (SG); Tianqi WANG, Singapore (SG); Massimo ALIOTO, Singapore (SG)

(73) Assignee: NATIONAL UNIVERSITY OF SINGAPORE, Singapore (SG)

(21) Appl. No.: 18/873,173

(22) PCT Filed: Jun. 9, 2023
(86) PCT No.: PCT/SG2023/050412

§ 371 Date: Dec. 9, 2024

(30) Foreign Application Priority Data
Jun. 9, 2022 (SG) 10202250105D

(51) Int. Cl. G06F 21/75

(52) U.S. Cl. CPC G06F 21/75

(57) ABSTRACT

Disclosed is an impedance monitoring system for detection of attacks on a secure system. The impedance monitoring system comprises a perturbation current generator (PCG), a voltage sensing ring oscillator (VSRO), and a controller. The PCG generates a perturbation current to excite a supply impedance of the secure system and the controller counts oscillations in the VSRO, resulting from voltage changes in the secure system, to detect an attack. In particular, the controller detects an attack by capturing a reference VSRO count, capturing a subsequent VSRO count for a non-zero perturbation current, and normalising the subsequent VSRO count based on the reference VSRO count.

### TECHNICAL FIELD

The present invention relates, in general terms, to an impedance monitoring system for detection of attacks on a secure system. More particularly, the invention relates to, but is not limited to, a fully-digital broadband calibration-less impedance monitor for probe insertion detection thereby to protect against power analysis attacks.

### BACKGROUND

Among physical-layer attacks, power analysis is a fundamental threat to data security as it exploits the on-chip information leakage through data-dependent chip consumption, retrieving confidential information (e.g., crypto-keys) in a non-invasive fashion. State-of-the-art counteraction techniques withstand attacks based on billions of power traces, and their complexity can be effectively reduced via regular crypto-key update in cost-sensitive devices. Such methods counteract attacks a priori but cannot detect attack execution. Unfortunately, attack execution often indicates a more dangerous threat escalation.

In general, power analysis monitors the supply current with series insertion of a probing device, violating the integrity of the off-chip supply network and modifying the supply impedance. Detection methods involving monitoring supply resistance are restricted to the real part of the supply impedance in DC, which limits the applicability to attack setups based on simple probing resistors, and prohibits awareness of the supply environment above DC. Other attack detection schemes focus on the inductive component due to changes in the chip surroundings through a specialized port. These methods are unsuitable for supply monitoring considering their oscillatory nature. On-chip digital sampling oscilloscopes have been considered but do not readily support continuous run-time attack detection since they require dedicated software support (often unavailable since they interfere with workload execution) and require continuous in-field re-calibrations against temperature fluctuations.

It would be desirable to overcome or ameliorate at least one of the above-described problems, or at least to provide a useful alternative.

### SUMMARY

The present schemes demonstrate a novel supply impedance monitor for detecting insertion of probing devices and package/printed circuit board (PCB) modifications in secure systems, where the probing devices attempt to perform power analysis attacks. Embodiments of the impedance monitoring system are fully-digital architectures allowing automated and portable design for detection of attacks on a secure system.

Disclosed herein is an impedance monitoring system for detection of attacks on a secure system, comprising:
a perturbation current generator (PCG);
a voltage sensing ring oscillator (VSRO); and
a controller,
   wherein the PCG generates a perturbation current to excite a supply impedance of the secure system and the controller counts oscillations in the VSRO, resulting from voltage changes in the secure system, the controller being configured to detect an attack by:
capturing a reference VSRO count;
capturing a subsequent VSRO count for a non-zero perturbation current; and
normalising the subsequent VSRO count based on the reference VSRO count.

The reference VSRO count may be captured for zero perturbation current.

The controller may count oscillations in the VSRO only in a proper fraction of a perturbation cycle. The proper fraction may comprise a resonance peak of the VSRO. The controller may be configured to analyse a specific resonance peak.

The perturbation current generated by the PCG may excite the supply impedance at a predetermined frequency and current amplitude.

The controller may be configured to count oscillations in the VSRO by normalising a count of oscillations in the VSRO. The controller may detect the attack by identifying at least one of:
a change in height of a peak normalised count;
a change in excitation frequency of the perturbation current at which the peak normalised count occurs;
presence of a new peak; and
a resonance shape change.

The system may be integrated underneath a supply pad.

A frequency of the perturbation current may be generated using a ring oscillator and divider circuit.

Advantageously, the impedance monitoring system has broadband application. This enables detection of different attack scenarios from different probing devices to PCB/package modification or tampering. In some embodiments, the broad frequency range is from DC to 2 GHz (or higher), making the excitation of different supply impedances coming from the insertion of probing devices and PCB/package modification possible.

Advantageously, measurement techniques are established for enhanced sensitivity, resilience and calibration-less operation. In some embodiments, count sensitivity is enhanced through temporal zooming.

Advantageously, the impedance monitoring system can be implemented in a compact area—e.g. underneath a supply pad in some embodiments. The area of the proposed invention fits the area of a pair of supply pads (i.e. zero area overhead) allowing under-pad placement for inexpensive adoption.

Advantageously, some embodiments have a fully-automated standard-cell based design. All sub-modules of such embodiments can still retain fully-automated standard-cell based design for easy and wide adoption, system integration and in-situ detection. Automated placement and routing (PNR) in a single design iteration avoids manual optimization and iterative PNR.

As used herein, “full automation” includes insertion of the detection circuitry onto the system on chip design being carried out through common automated digital design flows.

As used herein, the term “standard cell” includes elementary cells that are used to automatically generate a digital design. These cells are placed and then routed to implement the intended function. The intention is that the proposed detection technique can be designed by reusing common standard cells, and automated digital design flows. So, there is no need to specify the specific cells.

As used herein, the term “sub-modules” and similar refers to building blocks of the proposed detector architecture, being the building blocks or chip or architecture shown in FIG. 2.

### BRIEF DESCRIPTION OF THE DRAWINGS

Embodiments of the present invention will now be described, by way of non-limiting example, with reference to the drawings in which:

FIG. 1 illustrates both a schematic of a chip under power analysis attack, and the effect of a probing device on the supply impedance;

FIG. 2 is a schematic illustration of a supply impedance monitoring architecture of a system in accordance with present teachings, for detection of attacks on a secure system;

FIG. 3 shows temporal zooming for maximum count sensitivity around resonance peaks;

FIG. 4 illustrates the reduction in impact of inherent process, voltage, temperature variations and noise (PVT) and noise achieved using ratiometric measurements;

FIG. 5 demonstrates that VSRO count describes the frequency response of resistor, inductor, capacitor (RLC) impedances resulting from adding various PCT parasitics;

FIG. 6 shows the robustness of the normalised VSRO count, with respect to voltage changes;

FIG. 7 shows the robustness of the normalised VSRO count, with respect to temperature changes;

FIG. 8 shows measurements enabling detection of resistance changes under a 1-Ω probing resistor and using the system of FIG. 2, and the error distribution with and without insertion of the probe;

FIG. 9 shows measurements enabling detection of capacitance changes under a 1-Ω probing resistor and using the system of FIG. 2, and the error distribution with and without insertion of the probe;

FIG. 10 shows measurements enabling detection of inductance changes under a 1-Ω probing resistor and using the system of FIG. 2, and the error distribution with and without insertion of the probe;

FIG. 11 shows measurements enabling detection of combined capacitance and inductance changes under a 1-Ω probing resistor and using the system of FIG. 2, and the error distribution with and without insertion of the probe;

FIG. 12 shows the system of the present teachings can detect a state-of-the-art active current probe; and

FIG. 13 shows changes in quality (Q) factor due to inductance and capacitance changes, leading to a resonance shape change.

### DETAILED DESCRIPTION

Described below are novel supply impedance monitoring systems for detecting insertion of probing devices and package/PCB modifications in secure systems, to protect against power analysis attacks. Some embodiments of the system are fully-digital architectures, allowing monitoring automation. Moreover, the system is implemented in a highly compact area, allowing under-pad placement at zero area overhead. In addition, measurement techniques employed by some instances of the system ensure mitigation of environmental variations at no calibration cost and maximises the sensitivity to reactance.

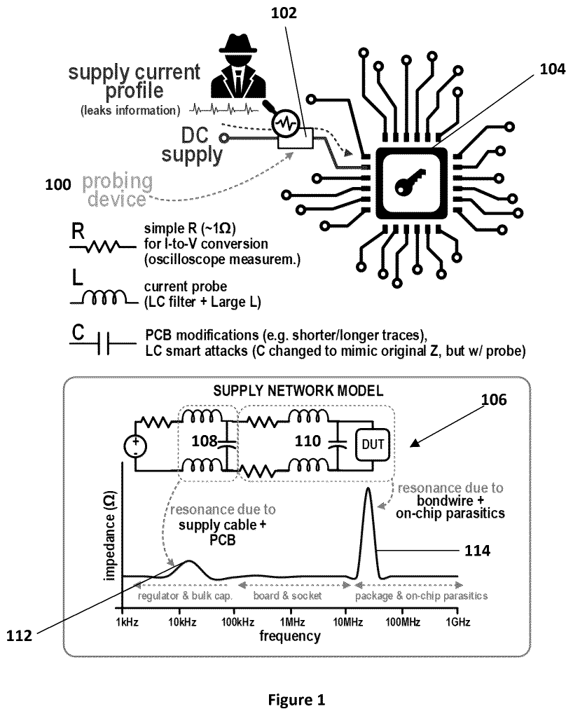

With reference to FIG. 1, the top figure illustrates power analysis attacks. The probing device 100 probes the supply network 102. The probe may be a simple resistance probe or current probe, or involve PCB modifications or inductor capacitor attacks where, for example, the capacitance is changed to mimic the original impedance taking into account the impedance of the probe itself. The supply current profile is measured, thereby leaking information such as a cryptographic key 104.

The bottom image in FIG. 1 shows a schematic model 106 of a supply network with resonance across the supply 108 caused by the supply cable and PCB, and resonance across the load 110 caused by the bondwire or package and on-chip parasitics. These resonances cause peaks 112, 114, respectively, in the impedance at particular frequencies. The change in the supply impedance profile over frequency is the result of an attack by insertion of a probing device to tamper with the PCB/package parasitics.

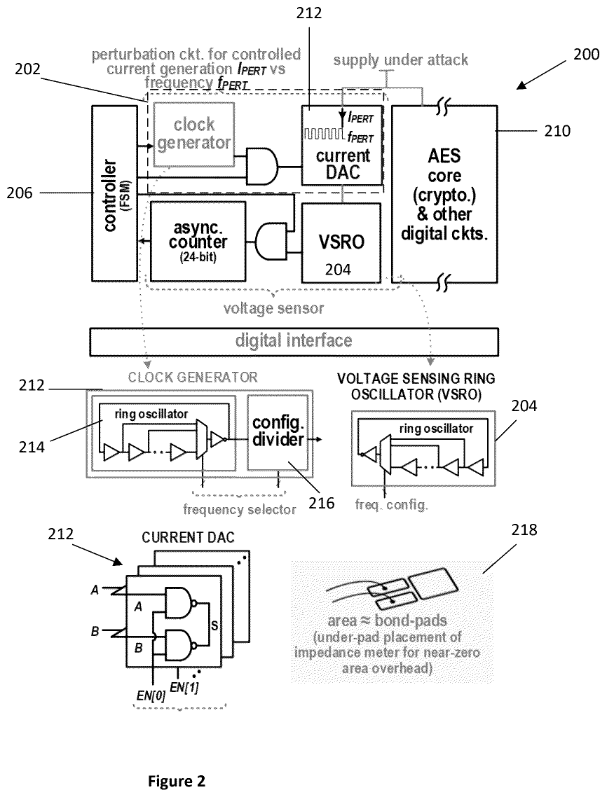

FIG. 2 shows an impedance monitoring system 200 for detection of attacks on a secure system such as those shown in FIG. 1. The system 200 comprises a perturbation current generator (PCG) 202, a voltage sensing ring oscillator (VSRO) 204 and a controller 206. The PCG 202 generates a perturbation current to excite a supply impedance of the secure system 210. This results in voltage changes in the secure system. The controller 206 counts oscillations in the VSRO 204 resulting from those voltage changes.

The controller 206 captures a reference VSRO count—i.e. VSRO count without perturbation current I_{PERT}. The controller 206 then captures a subsequent VSRO count for a non-zero perturbation current. The controller 206 detects an attack by normalising the subsequent VSRO count based on the reference VSRO count. The controller 206 of the proposed impedance monitor architecture thus enables the techniques below for enhanced resiliency/sensitivity.

The perturbation current I_{PERT} may be generated by any appropriate means or received from external supply. In the embodiment of FIG. 2, I_{PERT} is generated by a power digital-to-analog converter (DAC) 212, thereby to excite the supply impedance at the intended or predetermined frequency and current amplitude. The frequency on the analog current generated in the power DAC 212 is governed by a clock generator 214. The clock generator 214 presently comprises a ring oscillator 216 and frequency selector 218.

The VSRO 204 performs nearly-linear conversion of voltage deviations to frequency—i.e. it generates a count of deviations. The impedance monitoring system 200 excites the supply impedance of the secure system 210 with a controlled current I_{PERT} and measures the subsequent voltage changes by counting oscillations in the voltage sensing ring oscillator (VSRO) 204 for fully digital automated monitoring of supply side impedance.

As reflected at 218, the area occupied by system 200 is roughly equal to or potentially less than the size of the bond pads of a supply side impedance meter or other device, enabling integration underneath a pad for zero or near-zero area overhead.

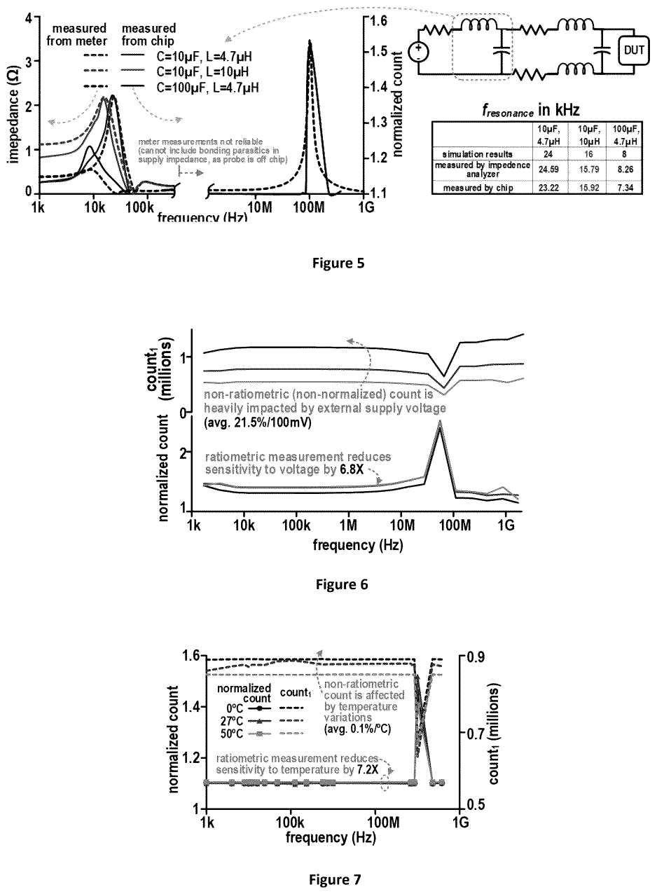

The system 200 covers a wide range of attack scenarios at run time from probing resistors (DC) to package modification attacks in the frequency range from DC to 2 GHz. In comparison to heretofore known system in supply impedance or environment monitoring, the normalized area of the proposed invention is 21× smaller than sampling oscilloscope detection systems and 67× smaller than systems that monitor inductance through a specialized port—moreover, such system are not suitable for supply side monitoring. Broadband operation up to 2 GHz is demonstrated through experimentation, removing the restriction to resistance and inductance in previous systems, while achieving a 2.5× broader bandwidth than known systems. Its fully-digital design and small size simplifies integration and portability, and resilience against variations and noise, as shown with reference to FIGS. 5 to 12, can dispense with calibration or software support.

Perturbation frequencies f_{PERT} in the range of DC to 2 GHz are generated on-chip using a clock 212, the clock 212 employing a ring oscillator (RO) 214 and divider circuitry 216 for frequency selection. The broad f_{PERT} range enables the detection of different probing devices such as resistance, inductance, capacitance, joint capacitance and inductance, smart attack, and state-of-the-art current probes, and PCB/package modifications. Variations in the supply voltage due to the insertion of a probing device are sensed using VSRO 204.

The controller 206 enables the measurement techniques such as temporal zooming to be used. Temporal zooming maximizes the count sensitivity to reactance or changes in impedance. This is achieved by altering the temporal resolution (expanding or contracting the timeframe over which a peak is detectable) for the count or of the viewing window over which peaks in current, resistance, inductance or combinations thereof, are identified to expose variations that are more difficult to discern at other temporal resolutions. Counting at the VSRO 204 only in a proper fraction of a perturbation cycle time T_{PERT}, and using ratiometric acquisitions (i.e. the output being directly proportional to the input), supresses the global process, voltage and temperature variations.

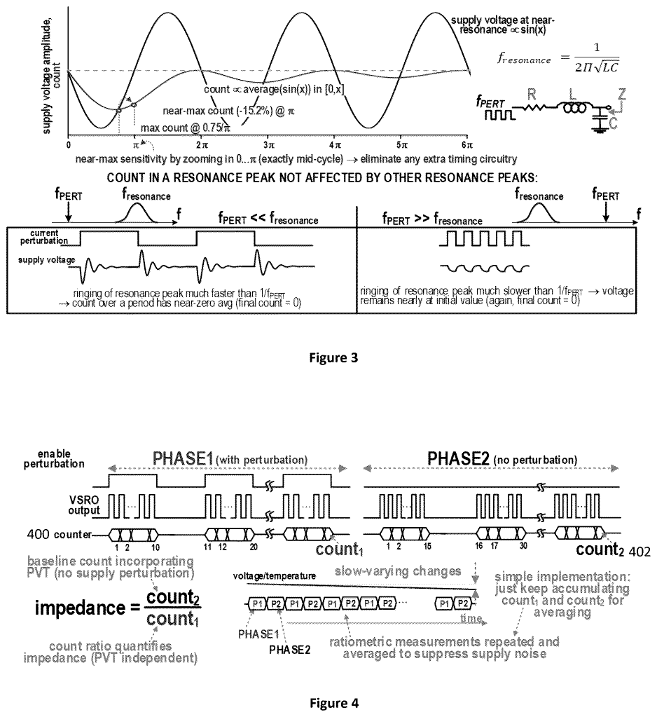

When the perturbation frequency 1/T_{PERT} is near a resonance peak f_{RESONANCE}, the sustained voltage oscillation has near-zero average. Consequently, continuous counting would not measure the corresponding impedance. Thus, the proper fraction of T_{PERT} is determined with reference to a resonance peak of the VSRO. In particular, the controller is configured to analyse a specific window of the perturbation cycle. In some embodiments, the specific window comprises a time point of 37.5% of each perturbation cycle—i.e. 37.5% into a perturbation cycle such that VSRO count needs to be activated in a window of 0.375·T_{PERT}. This maximizes the VSRO count and hence reactance differentiation. The specific window can be adjusted for simplicity, without significant loss of accuracy. For example, the specific window may comprise a time point of halfway through each perturbation cycle—i.e. a time point approximated by 0.5·T_{PERT}—for simple implementation. An active-high counter enables the count to be directly driven by the perturbation signal, sacrificing only 15.2% of the VSRO count at 0.5·T_{PERT}. In other words, As shown in FIG. 3, the supply voltage deviation from the initial value under near-resonant frequency is most pronounced at time equal to 0.375*T_{PERT} (see minimum of the voltage waveform in the same plot). The corresponding count of VSRO pulses is hence maximum. This means that maximum detection sensitivity to supply deviations is achieved when evaluating the count at t=0.375*T_{PERT}. Nevertheless, the choice t=0.5*T_{PERT} keeps the count nearly the same with a minimal loss in sensitivity. At the same time, evaluating the count at t=0.5*T_{PERT} is typically much simpler than at t=0.375*T_{PERT} since the former value simply requires the count readout in the middle of the T_{PERT} period (e.g., by reading the count at the intermediate edge of the T_{PERT} periodic waveform, which is available for free). Of course, this leads to a simpler implementation, but in principle one could still use t=0.375*T_{PERT} as count readout point, although at the cost of more complex timing.

Temporal zooming as described herein allows selective analysis of a specific resonance peak. Peaks at higher frequency are inherently masked from the count. Indeed, such peaks have a much faster response than T_{PERT}, and hence have enough time to reach the steady state (to cause a voltage and count deviation). Similarly, Peaks at lower frequency are inherently masked from the count. Indeed, such peaks have a much slower response than T_{PERT}, and hence do not have enough time to reach the steady state. In each case, this leads to zero average across ringing periods.

FIG. 4 illustrates global process variations, moderately fast voltage fluctuations and temperature variations that are suppressed through ratiometric acquisitions. For ratiometric readout, a reference VSRO count 400 is first acquired with I_{PERT}=0 (zero perturbation current). Capturing at I_{PERT}=0 captures environmental variations in a baseline count. A second perturbed measurement 402 with the intended I_{PERT} is performed immediately thereafter. The count is normalized to the former and can be used to quantify the relative change. The VSRO count (induced by the supply voltage change) due to the I_{PERT} current with perturbation is simply divided by the count without perturbation current (as a baseline). Both counts are equally affected by process, voltage, temperature variations and time-averaged noise throughout the count. Hence, their ratio is nearly independent of these non-idealities and becomes robust against variations and noise. That relative change is voltage and temperature-independent. Fast voltage fluctuations (e.g., due to the current absorbed by other circuits) are handled as noise, and are mitigated through averaging by repeating the same (ratiometric) measurement and accumulating the counts without reset in-between.

Measurements were taken on a 28-nm test chip showing that VSRO count describes the frequency response of RLC impedances as reflected by FIG. 5. The adopted ratiometric count is inherently robust against supply voltage and temperature fluctuations as reflected in FIGS. 6 and 7. This reduces the VSRO count sensitivity by 6.8× and 7.2×, compared to an absolute count.

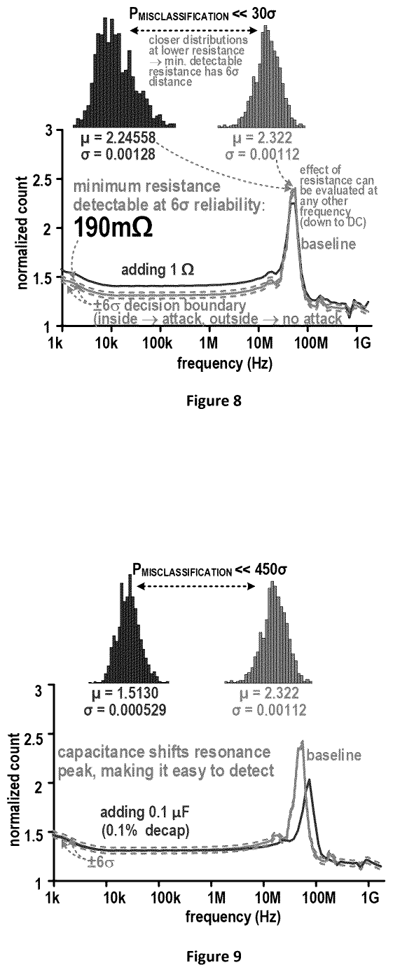

FIG. 8 shows the detection of a 1-Ω probing resistor, and the error distribution without and with insertion. Based on the normalised count distributions in FIG. 8, discrimination is between attack and non-attack cases is simple and robust with a distance of more than 300, and a minimum detectable resistance of 190 mΩ at 6-σ reliability. A decision boundary of 6σ is nominally considered in all attacks below, to differentiate from non-attacks. The ability to differentiate the two counts under attack and no attack (i.e., with and without a change in the supply network) is routinely quantified through the statistical distributions of the count under those two conditions. In particular, robustness is quantified by the distance of the mean value μ of the count under attack and no attack, and then dividing the distance by the sum of the standard deviations σ of the two distributions.

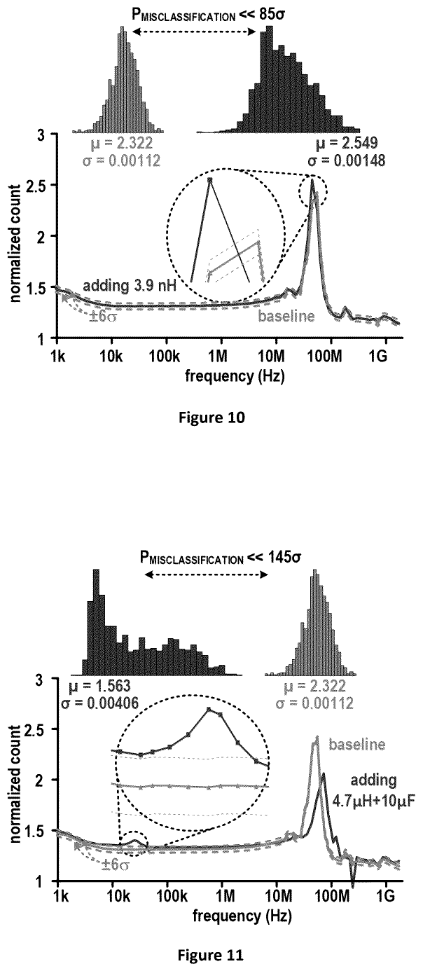

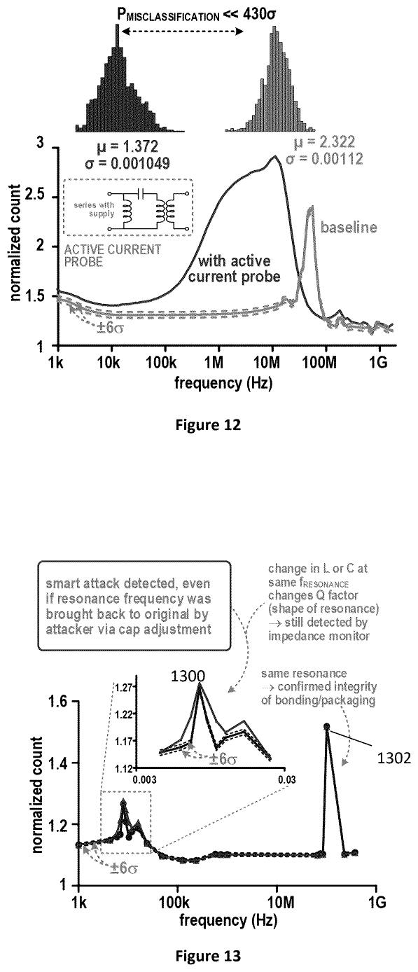

The same considerations hold, but for even higher σ distances, for capacitance changes, inductance changes and joint capacitance and inductance changes as reflected in FIGS. 9 to 11. With regard to FIGS. 10 and 11, the controller detects the attack by identifying a change in excitation frequency of the perturbation current at which the peak normalised count occurs. With regard to FIG. 11, the controller detects the attack by identifying presence of a new peak as reflected in the exploded section of the trace. Detection of a state-of-the-art active current probe is shown in FIG. 12, where the resonance frequency shift due to its additional inductance is detected. The controller may detect the attack by identifying a change in height of a peak normalised count, frequency at which the peak occurs and various other measures. The peak itself is clearly delineated from the peak at which no attack was occurring-baseline trace.

The controller may thus similarly detect the attack by identifying a resonance shape change. Even if the attacker manipulates the passive impedances (e.g., capacitors) after inserting an inductive probing device to mimic the same resonance frequency ∝1/(LC)^{0.5}, the Q factor ∝(L/C)^{0.5} nevertheless changes due to L and C, leading to a resonance shape change as reflected in FIG. 13. For example, a smart attack may bring the resonant frequency back to the original resonant frequency yet the normalised count will identify the manipulation via shape change of the resonance since a change in inductance or capacitance at the same resonant frequency modifies the shape of the frequency peak. Thus, that manipulation is still detected by the system 200. This is reflected at numeral 1300, which can be compared with the peak at 1302 in which the integrity of the bonding or packaging (i.e. that there is no attack taking place) is confirmed by comparable peak shape.

When compared with previous supply monitoring systems, for monitoring impedance or environment monitoring, the normalized area of the system 200 is comparable to previous supply resistance monitoring technologies. Moreover, the system 200 is far smaller than on-chip digital sampling oscilloscope technologies and technologies using a specialised port for detection of changes on the inductive component. In some embodiments, the system 200 can fit a pair of supply pads, enabling integration underneath a pad at zero area overhead. Broadband operation up to 2 GHz has been demonstrated, removing the restriction to resistance and inductance in previous technologies, while achieving a 2.5× broader bandwidth than on-chip digital oscilloscope technologies. Resilience against variations and noise removes the need for calibration or software support, as opposed to known technologies. Also, appropriate measurement techniques, the results of which are shown in FIGS. 5 to 12, ensure mitigation of environmental variations at no calibration cost and maximises the sensitivity to reactance.

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. An impedance monitoring system for detection of attacks on a secure system, comprising:
a perturbation current generator (PCG);
a voltage sensing ring oscillator (VSRO); and
a controller,
wherein the PCG generates a perturbation current to excite a supply impedance of the secure system and the controller counts oscillations in the VSRO, resulting from voltage changes in the secure system, the controller being configured to detect an attack by:
capturing a reference VSRO count;
capturing a subsequent VSRO count for a non-zero perturbation current; and
normalising the subsequent VSRO count based on the reference VSRO count.

2. The system of claim 1, wherein the reference VSRO count is captured for zero perturbation current.

3. The system of claim 1, wherein the controller counts oscillations in the VSRO only in a proper fraction of a perturbation cycle.

4. The system of claim 3, wherein the proper fraction is determined with reference to a resonance peak of the VSRO.

5. The system of claim 3, wherein the controller is configured to analyse a specific window of the perturbation cycle.

6. The system of claim 5, wherein the specific window comprises a time point of 37.5% of each perturbation cycle.

7. The system of claim 5, wherein the specific window comprises a time point of halfway through each perturbation cycle.

8. The system of claim 1, wherein the perturbation current generated by the PCG excites the supply impedance at a predetermined frequency and current amplitude.

9. The system of claim 1, wherein the controller is configured to count oscillations in the VSRO by normalising a count of oscillations in the VSRO.

10. The system of claim 9, wherein the controller detects the attack by identifying a change in height of a peak normalised count.

11. The system of claim 9, wherein the controller detects the attack by identifying a change in excitation frequency of the perturbation current at which the peak normalised count occurs.

12. The system of claim 9, wherein the controller detects the attack by identifying presence of a new peak.

13. The system of claim 9, wherein the controller detects the attack by identifying a resonance shape change.

14. The system of claim 9, wherein the controller detects the attack by identifying a resonance frequency shift.

15. The system of claim 1, being integrated underneath a supply pad.

16. The system of claim 1, wherein a frequency of the perturbation current is generated using a ring oscillator and divider circuit.
